(19) United States
(12) Patent Application Publication
(10) Pub. No.: US 2015/0289323 A1
(43) Pub. Date: Oct. 8, 2015

(54) THERMAL REACTOR

(71) Applicant: BTU International, Inc., North Billerica, MA (US)

(72) Inventors: Donald A. Seccombe, JR., Gloucester, MA (US); Ramesh D. Peelamedu, Andover, MA (US)

(21) Appl. No.: 14/624,092

(22) Filed: Feb. 17, 2015

Related U.S. Application Data
(60) Provisional application No. 61/975,145, filed on Apr. 4, 2014.

(51) Int. Cl. H05B 6/64; H05B 6/74; H05B 6/78; H05B 6/68

(52) U.S. Cl. CPC H05B 6/6491; H05B 6/645; H05B 6/6482; H05B 6/68; H05B 6/74; H05B 6/78

(57) ABSTRACT

The present invention comprises a thermal reactor and method for thermal processing of particles carried in a gas stream through the reactor. The reactor system can operate in a continuous manner for the thermal processing of particles flowing through the reactor. The system in one embodiment employs a hybrid of microwave and radiant heating of the particles. In other embodiments, only microwave heating is employed, or only radiant heating is employed.

### STATEMENT REGARDING FEDERALLY SPONSORED RESEARCH OR DEVELOPMENT

N/A

### BACKGROUND OF THE INVENTION

Systems and Processes are known for exfoliation of carbon or other materials by which materials having a layered structure are separated into individual sheets or flakes. In general, known systems have been of small or laboratory scale. It would be beneficial to have a system for exfoliation and similar processes which is operative on a commercial scale for processing commercially significant quantities of carbon or other materials in an efficient and cost effective manner.

### BRIEF SUMMARY OF THE INVENTION

The present invention comprises a thermal reactor and method for thermal processing of particles carried in a gas stream through the reactor. The reactor system can operate in a continuous manner for the thermal processing of particles flowing through the reactor. The system in one embodiment employs a hybrid of microwave and radiant heating of the particles. In other embodiments, only microwave heating is employed, or only radiant heating is employed.

In one embodiment of a hybrid microwave-radiant heating system, a reactor tube is provided within a housing and which is composed of quartz or other material which is microwave transparent and able to withstand the operating temperature of the reactor. The quartz tube defines a furnace or reactor chamber which may be divided into one or more zones. An inlet is provided at one end of the reactor tube for introduction of gas and particles to be processed. An outlet is provided at the opposite end of the reactor tube for collection of the particles after processing. An exhaust can be provided at or near the outlet end of the reactor tube for removal of gas from the tube. A plurality of susceptors are disposed around the reactor chamber in at least one zone thereof, the susceptors being positioned between the reactor tube wall and a hot box which contains a plurality of microwave sources. The plurality of microwave sources are arranged in the hot box to provide microwave radiation in the chamber to uniformly heat the particles transported through the chamber by the gas stream. The microwave sources are also operative to provide uniform heating of the plurality of susceptors. At temperatures greater than about 600° C., the susceptors are effective upon microwave heating by the microwave sources to provide uniform radiant heating of the particles being transported through the chamber.

In a preferred embodiment, the susceptors comprise a plurality of rods each composed of high temperature high purity composite ceramic material, the rods being disposed in spaced relation around the chamber in at least one zone of the chamber and positioned to receive microwave radiation from the plurality of microwave sources and to provide radiant energy to the particles being transported through the chamber. The susceptor rods can vary in number and spacing and position in the chamber in order to adjust the power levels and heat profiles suitable for the particular particles being processed.

The power per unit volume of the susceptors is determined to provide an intended amount of microwave absorption by the susceptors in order to absorb sufficient microwave energy for heating of the susceptors and emission of radiant energy onto the particles in the chamber.

For lower operating temperatures, typically less than about 600° C., the susceptors do not produce much radiant heating of the particles but serve to provide more uniform microwave heating of the particles by control of the microwave fields.

Each of the microwave sources is composed of a relatively low power and low cost magnetron coupled to a horn mounted about a chamber wall and operative to introduce microwave energy into the chamber. A plurality of such sources are disposed in an array operative to introduce microwave energy into the chamber. The magnetrons are powered by respective power supplies or, alternatively, by one or more shared power supplies to provide requisite electrical power to the magnetrons. The power to the magnetrons is controllable by associated power controllers for varying the power provided by the respective sources and for switching the respective sources on and off. The number and spacing of sources within the microwave array can be selectively determined, as can the power provided to each of the sources of the array in order to produce an intended power level and/or profile of microwave energy introduced into the chamber.

One or more mode stirrers, which per se are known in the art, are provided in the hot box and are operative to mix the microwave modes to provide more uniform electric field within the chamber. In one preferred embodiment two mode stirrers are employed on respective sides of the hot box.

A microwave choke is provided at the inlet end and outlet end of the reactor to prevent leakage of microwave energy to the external environment.

The system includes a control system for independent control of each of the microwave sources and closed loop control of the temperatures in the reactor chamber. Thermocouples or other temperature sensors can be provided in the chamber for monitoring chamber temperature, and an infrared pyrometer or other sensor can be employed to measure the temperature of the particles being transported through the chamber. Signals from these sensors are provided to the control system and employed to control temperature to maintain an intended processing temperature. Different temperatures can be provided in respective zones of a multi-zone furnace to provide an intended thermal profile as particles are conveyed through the zones. The dielectric characteristics of the particles must be taken into account in order to achieve an intended processing profile and degree of control.

In operation, air or other gas is introduced into the inlet end of the reactor and particles of carbon or other material to be processed are also introduced into the inlet end of the reactor. The gas flow carries the particles through the reactor in which the particles are exfoliated or otherwise processed by the combined microwave and radiant heating provided by the magnetrons and susceptors. The particles are collected at the outlet end of the reactor and gas from the reactor can be exhausted to the atmosphere or reprocessed for reuse.

The invention can be employed for processes other than exfoliation. For example, the invention can be employed to provide thermal and gas conditions for initiating or enhancing chemical reactions of material carried through the reactor, typically in particulate or powder form.

In other aspects of the invention, heating can be accomplished solely by microwave energy provided by one or more magnetrons. In yet another aspect of the invention, heating is provided solely by radiant heating from one or more radiant heat sources.

### BRIEF DESCRIPTION OF THE SEVERAL VIEWS OF THE DRAWINGS

The invention will be further understood from the following detailed description taken in conjunction with the drawings in which:

FIG. 1A is a diagrammatic elevation view of a continuous flow vertical thermal reactor in accordance with the invention;

FIG. 1B is a top view of the reactor of FIG. 1A;

FIG. 2A is a pictorial view of one embodiment of a magnetron assembly usable in the inventive system;

FIG. 2B is a cutaway elevation view of the magnetron assembly of FIG. 2A;

FIG. 3 is a block diagram of a control system in accordance with the invention; and

FIG. 4 is a diagrammatic illustration of power monitoring apparatus useful in the invention.

### DETAILED DESCRIPTION OF THE INVENTION

This application claims priority benefit of U.S. provisional patent application no. 61/975,145, filed Apr. 4, 2014 and is incorporated herein by reference.

### Overall System

In one aspect, the invention is employed for thermal exfoliation of graphene, graphite. carbon or other particles to create flake like materials.

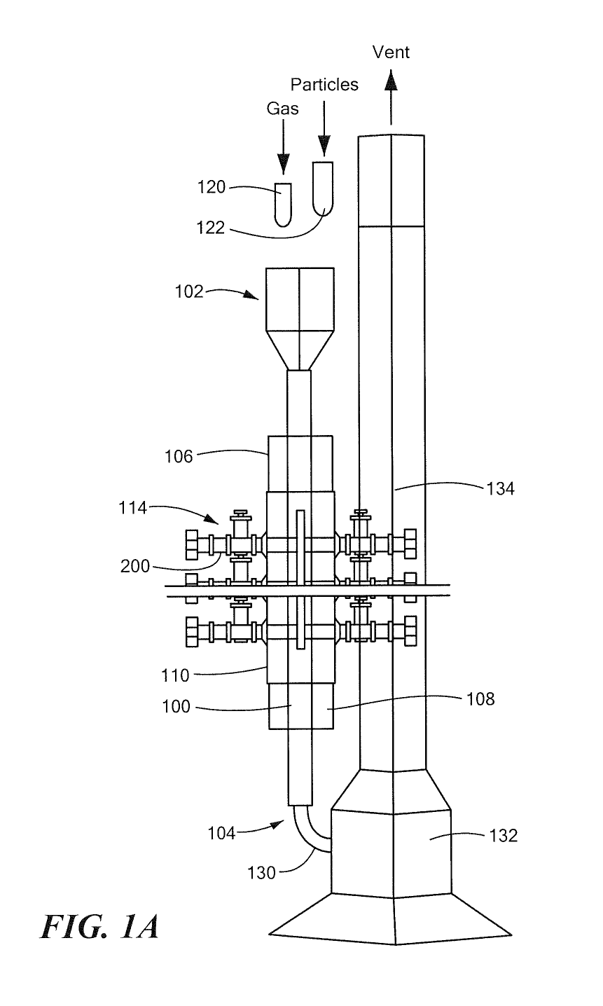

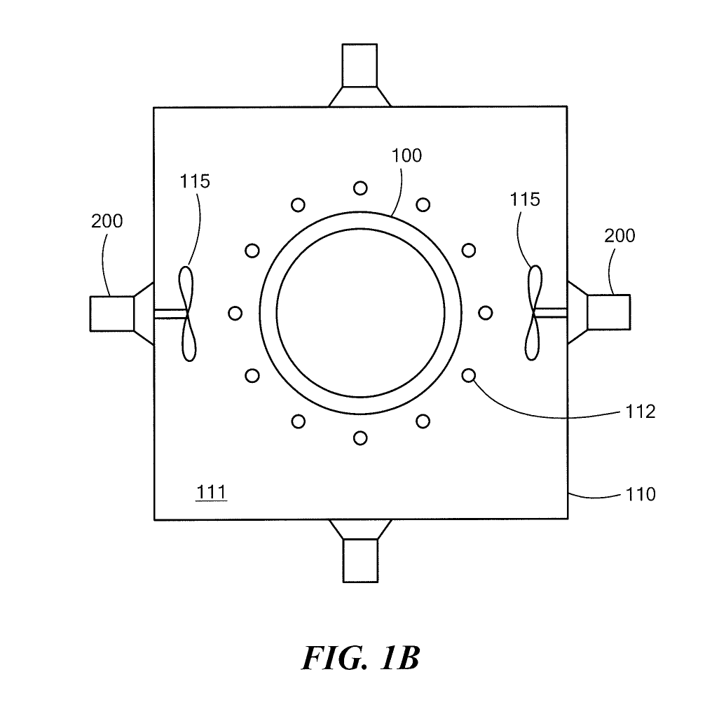

An embodiment of a continuous thermal reactor in accordance with the invention is illustrated diagrammatically in FIGS. 1A and 1B. The system includes a quartz tube 100 having an inlet end 102 and an outlet end 104. A microwave choke 106 is provided at the inlet end of the reactor, and a microwave choke 108 is provided at the outlet end of the reactor. The chokes are identical in construction and in the illustrated embodiment are two stage chokes such as shown and described in co-pending application Ser. No. 14/047,172, filed Oct. 7, 2013 incorporated herein by reference. A furnace or reactor chamber is provided in the quartz tube between the chokes. The chamber may be divided into one or more heating zones. In the illustrated embodiment, a single zone is shown. A hot box 110 is provided around the tube and contains a plurality of susceptor rods 112, to be described below, and an array 114 of magnetrons operative to introduce microwave energy from each of the magnetrons of the array into the reactor chamber for microwave heating of the particles passing through the chamber. The microwave energy from the magnetron array is also operative to heat the susceptors disposed in the hot box and which, upon microwave heating, produce radiant energy directed to the particles passing through the reactor tube. The particles conveyed through the reactor are heated by a controlled combination of radiant energy from the susceptors and microwave energy from the magnetron array to provide rapid and efficient exfoliation of the particles. The reactor in this illustrated embodiment is typically operated in a temperature range between about 700 and 1150° C. It will be appreciated that the reactor can be implemented for operation at higher or lower temperatures to suit particular particle processing to be accomplished. The tube has a five inch diameter in the illustrated version.

At the inlet end 102 of the reactor, air or other gas is introduced via nozzle 120 and particles are introduced via a nozzle 122. The gas flow is less than 1 meter per second and typical flow rates are in the range of 0.3-0.4 meters per second. The system operates at atmospheric pressure and the chamber is open at the inlet and outlet ends to enable material flow. The maximum operating temperature is limited by the reactor material. For a quartz tube, the maximum operating temperature is 1150° C. Higher temperatures can be employed with other tube materials such as alumina or mullite or others. The inlet gas can be heated to a temperature in the 200 to 600° C. and can be reheated for re-introduction into the reactor after being exhausted.

The particles for the illustrated embodiment are graphene oxide or graphite particles. The particle flow rate is less than about 10 grams per second with a typical flow rate being 1-2 grams per second. The travel time of particles through a reactor tube having a 50 inch length is about 50 milliseconds to 300 milliseconds.

Two mode stirrers 115 are disposed in the hot box between the susceptors 112 and a wall of the hot box and are employed to provide a multi-mode microwave field in the reactor chamber.

The outlet end 104 is coupled by a tube 130 to a particle collector 132, the upper end of which is coupled to a gas exhaust duct 134 for venting gas to the atmosphere or a reprocessing unit. In one embodiment, the particles emitted at the outlet of the reactor strike a wall of the collector 132 and drop out of the gas stream.

### Magnetron Array

A plurality of microwave sources are arranged to provide uniform microwave radiation in the chamber to uniformly heat the particles transported through the chamber by the gas stream and to provide uniform heating of the plurality of susceptor rods. Each magnetron is coupled via a tunable waveguide to a horn mounted at or near the chamber wall and operative to introduce microwave energy into the chamber. A plurality of such sources are disposed in an array operative to introduce microwave energy into the chamber. In the illustrated embodiment an array of 12 microwave sources is provided arranged in a square 4×3 array. The number and placement of magnetrons and associated waveguides and horns is determined to produce a uniform microwave field in the chamber and uniform heating of the susceptors. As an alternative, the relative power of the magnetrons and their spacing and position within an array of magnetrons can be adjusted to produce a desired non-uniform distribution or profile of microwave energy in the chamber.

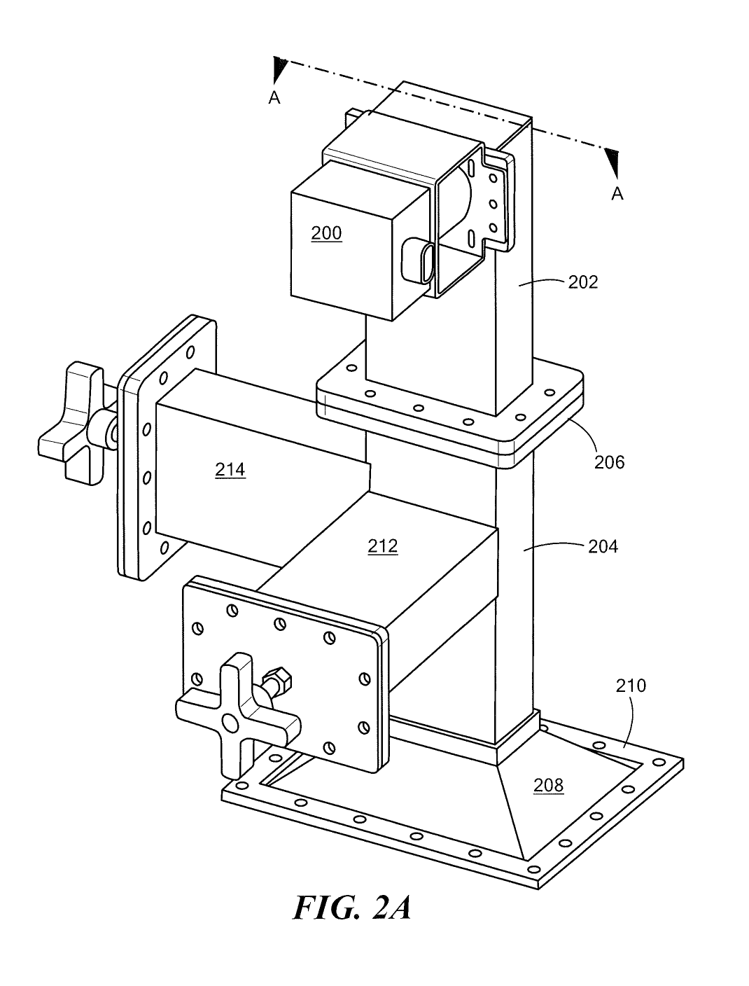

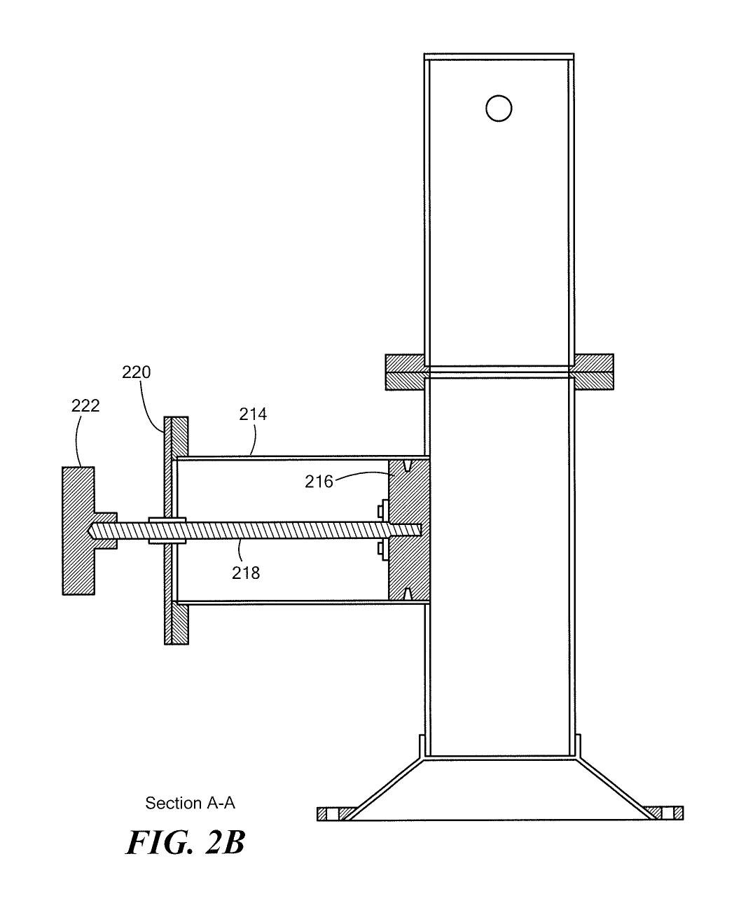

One of the microwave sources is illustrated in FIGS. 2A and 2B. A magnetron 200 is attached to a waveguide 202 which is attached to a waveguide 204 via a coupling 206. The waveguide is attached to a horn 208 which has a mounting flange 210 attachable to a wall of the hot box 110 by suitable fasteners cooperative with holes in the flange and aligned holes in the hot box. A tuning stub 212 is attached to the wider wall of waveguide 204, and a second tuning stub 214 is attached to the narrower wall of the waveguide. The tuning stubs are each 5λ/4 in length. The tuning stubs are disposed along the respective transverse axes of the waveguide 204 and are orthogonal to each other. Each of the tuning stubs includes a piston moveable along the length of the respective waveguide stub section. As seen in FIG. 2B, a piston 216 is attached to a rod 218 which extends through an opening in an end plate 220 and on the outer end of which is a central knob 222. The knob and connecting rod can be pushed inward and outward to adjust the position of piston 216 along the length of the stub 214. Each stub is tuned to maximize the forward power emanating from horn 208 into the chamber and to minimize the reverse or reflected power back to the magnetron. The pistons can be locked in position after tuning. The waveguides and horn are fabricated of aluminum or other suitable metal. The piston 216 is also fabricated of aluminum or other suitable metal. The piston arrangement for stub 214 illustrated in FIG. 2B is the same for stub 212.

The respective pistons for stubs 212 and 214 are slidable along the respective waveguide inner surfaces and each of the pistons includes a groove around the periphery thereof in which a metal or other conductive mesh gasket, is provided as illustrated in FIG. 2B, which is in contact with the confronting inner walls of the stubs to eliminate or minimize arcing which could occur across the gap between the wall and confronting piston surface.

The horn 208 is configured to provide high gain, low VSWR and relatively wide bandwidth and to serve as an impedance matcher between the waveguide and the free space of the chamber. The forward field is maximized by the matched termination provided by the horn and reflected waves are minimized. In one embodiment using a WR 430 waveguide, the magnetrons operate at 2.45 GHz, and the horns have a beam width of 20 degrees, and a gain of at least 15 dB and a return loss of <−10 dB. The radiation pattern of each horn overlaps the radiation pattern of the other horns of the microwave array to produce a substantially uniform radiation pattern throughout the volume of the chamber.

The microwave radiation is multi-mode in the chamber and one or more mode stirrers are employed to provide changing mode patterns to maintain uniformity of the electric field in the chamber. A mode stirrer 103 in shown in FIG. 1.

The magnetrons in the illustrated embodiment each have an output power of 1.1 kilowatts and are driven by a power supply which can be individually controlled. The maximum power of the array of 12 sources is about 13.2 kilowatts in this embodiment. The array of magnetrons is air cooled by directing air at high velocity onto the cooling vanes of the magnetrons to maintain the magnetrons below 60° C. at 100% power. Cooling air can also be directed to the power supplies to maintain a safe operating temperature. The cooling air is exhausted through one or more vents provided in the furnace housing.

The magnetron array is not limited to 12 magnetrons. The number and power output of the magnetrons can vary to achieve an intended power distribution with a high degree of uniformity and power level for the particles being processed.

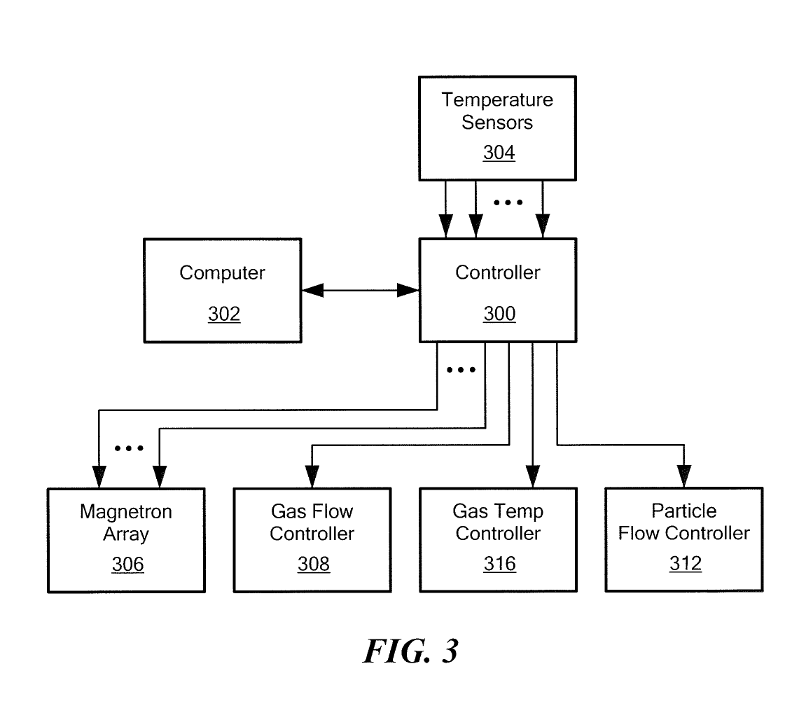

The control system for the reactor is illustrated in FIG. 3. The process control parameters governed by the control system are carrier gas flow rate, incoming gas temperature, microwave power, hot box process temperature, dwell time in the reactor chamber or along the reactor path, and particle flow rate.

A controller 300 cooperative with a computer 302 receives temperature signals from temperature sensors 304 in the reactor and provides control signals to the magnetron power supplies of the magnetron array 306. The controller can also provide control signals to the gas flow controller 308, gas temperature controller 310, and particle flow controller 312. The power output of each magnetron in the array is individually controllable so that the power level of the array of magnetrons can be tailored to provide uniform radiation or an intended radiation profile in the chamber. As a result of this control, an intended temperature or an intended temperature profile can be maintained in the furnace during an operating cycle. The controller operates in accordance with one or more control algorithms, such as PID (proportional integral derivative) control.

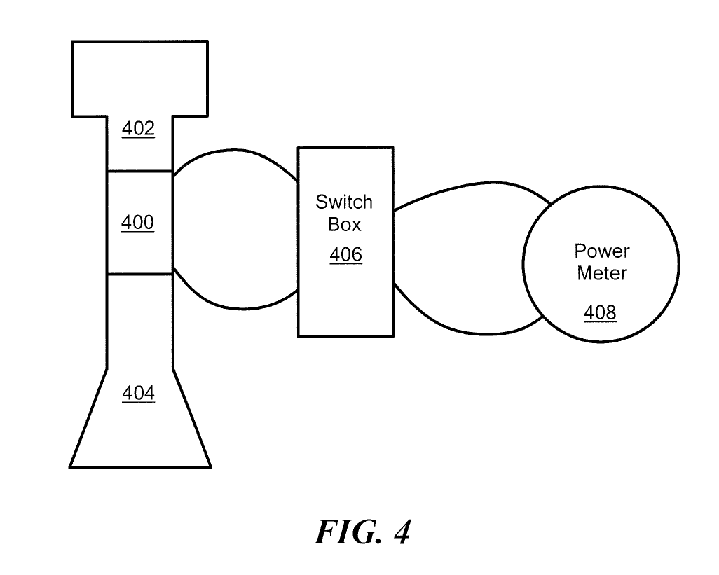

The power output of each magnetron in the magnetron array can be monitored and/or recorded by the apparatus shown in FIG. 4. A bi-directional coupler 400 is provided in each magnetron assembly, for example between waveguides 402 and 404. The coupler provides signals via a switch box 406 to a power meter 408. The coupler for each magnetron is connected in similar manner to the power meter via the switch box. The power meter is operative to display and/or record the power output readings of each magnetron in the array, as selected by use of the switch box 406. The magnetron outputs may be manually selected by manual operation of the switch box. Alternatively, the switching operation may be automated to sequentially read and/or record the power outputs of the magnetrons in the array. The switching can be governed, for example, by the controller 300 of the control system (FIG. 3).

### Hot Box and Susceptors

The hot box and susceptor rod arrangement is illustrated in FIG. 1B. The hot box 110 has metal walls which enclose a high purity, high temperature alumina or other material 111 which is transparent or transmissive to microwave energy and opaque to thermal energy at the frequency employed. A typical material is alumina insulating board. The metal walls of the hot box have apertures around which respective magnetron horns are mounted.

A plurality of susceptor rods 112 are disposed along the length of the box 110 between the first and second chokes 106 and 108. The 16 rods are equi-spaced from each other and are disposed around the quartz tube 100. The rods in the illustrated version are spaced 22.5° apart about a six inch circle. The susceptor rods are absorptive of microwave energy and are heated by the microwave energy and radiate heat to the particles transported in the gas stream through the chamber. In general, the microwave power is of a level to provide a penetration depth in the susceptor rods of about 50%.

The susceptor rods can be of any shape and size to produce the desired absorption and transmission of microwaves. The rods collectively provide an intended thermal mass to be heated by the microwaves and to radiate in the chamber to heat particles in the chamber. The susceptor rod sizes and the spacing between adjacent rods are determined to produce the intended temperature uniformity in the furnace chamber and to achieve acceptable heating efficiency. The efficiency is defined as the amount of heating accomplished for the least amount of power consumed by the magnetron array. One or more thermocouples can be disposed near the rods to provide temperature signals to the system controller. The susceptor rods are of a size and spacing to achieve uniformity of heating and balance between the microwave and the radiative heating of the particles. The susceptors are composed of high purity high temperature composite ceramic material having high microwave absorption, high mechanical strength and thermal shock resistance, low oxidation and low chemical degradation at high operating temperatures. Suitable materials are a ceramic material of the group consisting of SiC, SiO₂, Fe₂O₃ Si₃N₄, and Al₂O₃. In alternative embodiments the rods may be horizontally or otherwise displayed.

### Two Stage Chokes

The two stage microwave chokes 106 and 108 (FIG. 1A) are shown and described in the aforesaid co-pending application Ser. No. 14/047,172. In the illustrated embodiment the chokes are 5 inches square. Each choke includes a reflective section and an absorptive section. A channel is provided through the length of the choke and is lined with quartz and is aligned with the reactor tube 100.

The reflective section is operative to attenuate the microwave field by destructive interference. Orthogonal channels are provided and which are configured and dimensioned to reflect microwave energy from the main channel back into that channel 180° out-of-phase with the incident energy to thereby cancel or substantially attenuate the microwave field in the channel 64.

The absorptive section is operative to further attenuate the microwave field and can include rods or bars extending across the width of the channel and disposed at the top and bottom of the channel. The bars are composed of a microwave absorptive material which may the same material used in the susceptor rods or other composite or pure material having the requisite characteristics.

Radiation is reduced at the end of the reflective stage by about 90%. Microwave energy is further attenuated in the absorptive stage resulting in EMI leakage from the exit end of the choke of about 5 mw/cm² which is very low leakage and well below applicable standards for leakage from microwave sources.

The length of the choke stages and the number of reflective channels in the reflective stage and absorbing elements in the absorptive stage is determined to result in the desired attenuation of EMI leakage from the exit end of the choke.

### Example

Particles of carbon are supplied to nozzle 122 at a flow rate of 3 grams/second, and air is supplied to nozzle 120 at a temperature of 1000° C. and flow rate of 0.3 meters/second. The temperature in the reactor tube is 100° C. The travel time through a reactor tube having a length of 50 inches is 200 milliseconds and exfoliated particles accumulate in collector 132.

In addition to graphene oxide and graphite particles, other particles which can be processed by the invention include carbon, graphene nanoplatelets, tantalum diselenide, vermiculite, MoS2 and MnO2.

The invention can also be employed for other than exfoliation processes. For example the invention can be employed to provide thermal conditions for initiating or sustaining a chemical reaction of particles flowing through the reactor. In another example the invention can provide the thermal conditions for altering or providing intended material characteristics to material particles flowing through the reactor.

The thermal conditions provided along the reactor tube and the thermal profile provided therein can be tailored to suit the particular process being carried out by the reactor. Preferably, the heating is accomplished in a hybrid manner by the combination of microwave heating as described above. Alternatively, microwave only heating can be provided or radiant heating only can be provided to suit particular process requirements. The composition of the gas can also vary to suit process conditions.

The reactor tube path in the illustrated embodiment is a straight linear path. In other embodiments, the path can be nonlinear and can be bent in any desired shape to provide an intended process path length.

The invention is not to be limited by what has been particularly shown and described but is to encompass the spirit and full scope of the appended claims.

What is claimed is:

1. A thermal reactor system for hybrid microwave and radiant heating of particles transported through a reactor chamber, the system comprising:
a housing having an inlet end and an outlet end;
a chamber in the housing disposed between the inlet end and outlet end and having one or more zones;
a gas inlet for introducing a process gas stream in the inlet end of the chamber;
a particle inlet for introducing particles in the gas stream at the inlet end of the chamber;
a plurality of susceptors each composed of high temperature microwave absorptive material, the susceptors being disposed in spaced relation around the chamber in at least one zone thereof;
a plurality of microwave sources arranged to provide uniform microwave radiation in the chamber to uniformly heat particles transported through the chamber by the gas stream and to provide uniform heating of the plurality of susceptors;
the plurality of susceptors upon microwave heating by the plurality of microwave sources providing uniform radiant heating of the particles transported through the chamber;; and
a controller operative to control the power of the plurality of microwave sources to provide an intended thermal profile in the chamber, and operative to control the flow rate of the gas stream and flow rate of the particles through the chamber.

2. The system of claim 1 wherein the plurality of susceptors are rods of high temperature composite ceramic material.

3. The system of claim 1 wherein the plurality of susceptors each have:
high microwave absorption;
high mechanical strength;
high thermal shock resistance;
low oxidation at elevated temperature; and
low chemical degradation.

4. The system of claim 2 wherein each of the plurality of susceptor rods is composed essentially of a ceramic material of the group consisting of SiC, SiO₂, Fe₂O₃, Si₃N₄, Al₂O₃, MgO, CaO and Y₂O₃.

5. The system of claim 1 wherein the plurality of microwave sources provides a penetration depth in the plurality of susceptors of about 50%.

6. The system of claim 1 including a microwave choke at the inlet end of the chamber and a microwave choke at the outlet end of the chamber and operative to minimize microwave leakage from the chamber.

7. The system of claim 1 including at least one mode stirrer in the chamber.

8. The system of claim 1 wherein each of the plurality of microwave sources are tunable to provide in concert with the other ones of the plurality of microwave sources an intended electric field in the chamber.

9. The system of claim 8 wherein each of the plurality of microwave sources includes a magnetron.

10. The system of claim 2 wherein the plurality of susceptors are rods disposed in spaced relation to each other around the chamber.

11. The system of claim 10 wherein the plurality of susceptor rods are of a size and spacing to achieve uniformity of heating and balance between the microwave and the radiative heating of the particles flowing through the reactor.

12. The system of claim 1 including at least one temperature sensor for sensing temperature in the chamber and providing temperature signals to the controller.

13. The system of claim 1 wherein the controller is also operative to control the flow of particle injection rate.

14. The system of claim 1 wherein the housing includes a quartz tube defining the chamber therein.

15. The system of claim 14 including a microwave choke at the inlet end of the chamber and a microwave choke at the outlet end of the chamber;
a hot box provided around the quartz tube and enclosing the plurality of susceptors.

16. The system of claim 15 wherein the hot box is composed of a high temperature material which is transparent to microwave energy and substantially opaque to thermal energy at the microwave frequency employed.
